(19) United States
(12) Patent Application Publication
(10) Pub. No.: US 2022/0176247 A1
(43) Pub. Date: Jun. 9, 2022

(54) Non-Transitory Computer-Readable Medium And Video Game Processing System

(71) Applicant: SQUARE ENIX CO., LTD., Tokyo (JP)

(72) Inventors: Shinpei Sakata, Tokyo (JP); Youichiro Miyake, Tokyo (JP); Gautier Boeda, Tokyo (JP)

(73) Assignee: SQUARE ENIX CO., LTD., Tokyo (JP)

(21) Appl. No.: 17/545,568

(22) Filed: Dec. 8, 2021

(30) Foreign Application Priority Data
Dec. 8, 2020 (JP) 2020-203411

(51) Int. Cl. A63F 13/56; A63F 13/355

(52) U.S. Cl. CPC A63F 13/56; A63F 13/355; A63F 13/573; A63F 2300/538; A63F 2300/6607

(57) ABSTRACT

A non-transitory computer-readable medium including a video game processing program for causing a server to perform functions to control a character during progress of a video game is provided. The functions include: a selecting function configured to select a combination of objects in accordance with a progress status of the video game, the objects being to be used for satisfying a predetermined condition in the video game as an in-game condition; and a using function configured to cause the character to use the combination of the objects selected by the selecting function in order to satisfy the in-game condition.

### CROSS-REFERENCE TO RELATED APPLICATION

The present application claims priority to and the benefit of Japanese Patent Application No. 2020-203411 filed on Dec. 3, 2020, the disclosure of which is expressly incorporated herein by reference in its entirety for any purpose.

### BACKGROUND

At least one of embodiments of the present invention relates to a non-transitory computer-readable medium including a video game processing program and a video game processing system for causing a server to perform functions to control a character in progress of a video game.

Conventionally, a video game has been caused to proceed by causing a character to appear in the video game and controlling the character.

For example, Japanese Patent No. 5581232 discloses a system in which a video game is caused to proceed by automatically operating a character.

### SUMMARY

In the meantime, in a video game, a character may be automatically controlled so that the character uses one object (for example, an item) capable of carrying out a predetermined action for achieving a predetermined purpose. Generally, when a purpose in a video game is set, an automatically controlled character uses an object capable of a predetermined action with discovery of the object as a trigger.

Here, in a case where the character uses the object, there may occur a situation where a predetermined action does not contribute to achievement of a purpose due to other situations, or a character cannot find an object that can carry out the action. In other words, in order to cause a character to achieve a predetermined purpose, the character is caused to use one object capable of carrying out an action that contributes to achievement of the purpose. However, a problem has occurred that in a case where developers prepare (or set) more objects and the like that contribute to achievement of a purpose by usage thereof of a character in order to increase the number of control patterns, the burden on the developers regarding setting and management of data becomes heavy as a scale of a video game becomes large.

It is an object of at least one of embodiments of the present disclosure to solve the problem described above, and to cause an action of a character for achieving a predetermined purpose in a video game to have the variety while suppressing the burden on developers from increasing.

According to one non-limiting aspect of the present disclosure, there is provided a non-transitory computer-readable medium including a video game processing program for causing a server to perform functions to control a character during progress of a video game.

The functions include a selecting function configured to select a combination of objects in accordance with a progress status of the video game, the objects being to be used for satisfying a predetermined condition in the video game as an in-game condition.

The functions also include a using function configured to cause the character to use the combination of the objects selected by the selecting function in order to satisfy the in-game condition.

According to another non-limiting aspect of the present disclosure, there is provided a video game processing system for controlling progress of a video game in response to an operation of a user. The video game processing system includes a communication network, a server, and a user terminal.

The video game processing system includes a selector configured to select a combination of objects in accordance with a progress status of the video game, the objects being to be used for satisfying a predetermined condition in the video game as an in-game condition.

The video game processing system also includes a usage controller configured to cause a character to use the combination of the objects selected by the selector in order to satisfy the in-game condition.

According to still another non-limiting aspect of the present disclosure, there is provided a non-transitory computer-readable medium including a video game processing program for causing a user terminal to perform functions to control progress of a video game in response to an operation of a user.

The functions include a selecting function configured to select a combination of objects in accordance with a progress status of the video game, the objects being to be used for satisfying a predetermined condition in the video game as an in-game condition.

The functions also include a using function configured to cause a character to use the combination of the objects selected by the selecting function in order to satisfy the in-game condition.

According to each of the embodiments of the present application, one or two or more shortages are solved.

### BRIEF DESCRIPTION OF DRAWINGS

The foregoing and other objects, features and advantages of the present disclosure will become more readily apparent from the following detailed description of preferred embodiments of the present disclosure that proceeds with reference to the appending drawings:

FIG. 1 is a block diagram illustrating an example of a configuration of a video game processing system corresponding to at least one of the embodiments of the present disclosure;

FIG. 2 is a block diagram illustrating a configuration of a server corresponding to at least one of the embodiments of the present disclosure;

FIG. 3 is a flowchart illustrating an example of game processing corresponding to at least one of the embodiments of the present disclosure;

FIG. 4 is a flowchart illustrating an example of an operation of a server side in the game processing corresponding to at least one of the embodiments of the present disclosure;

FIG. 5 is a flowchart illustrating an example of an operation of a terminal side in the game processing corresponding to at least one of the embodiments of the present disclosure;

FIG. 6 is a block diagram illustrating a configuration of a server corresponding to at least one of the embodiments of the present disclosure;

FIG. 7 is a flowchart illustrating an example of game processing corresponding to at least one of the embodiments of the present disclosure;

FIG. 8 is a block diagram illustrating a configuration of a server corresponding to at least one of the embodiments of the present disclosure;

FIG. 9 is a flowchart illustrating an example of game processing corresponding to at least one of the embodiments of the present disclosure;

FIG. 10 is a block diagram illustrating a configuration of a server corresponding to at least one of the embodiments of the present disclosure;

FIG. 11 is a flowchart illustrating an example of game processing corresponding to at least one of the embodiments of the present disclosure;

FIG. 12 is a block diagram illustrating a configuration of a server corresponding to at least one of the embodiments of the present disclosure;

FIG. 13 is a flowchart illustrating an example of game processing corresponding to at least one of the embodiments of the present disclosure;

FIG. 14 is a block diagram illustrating a configuration of a server corresponding to at least one of the embodiments of the present disclosure;

FIG. 15 is a flowchart illustrating an example of game processing corresponding to at least one of the embodiments of the present disclosure;

FIG. 16 is a block diagram illustrating a configuration of a server corresponding to at least one of the embodiments of the present disclosure;

FIG. 17 is an explanatory table for explaining an example of a storage state of information corresponding to at least one of the embodiments of the present disclosure;

FIG. 18 is a flowchart illustrating an example of game processing corresponding to at least one of the embodiments of the present disclosure;

FIG. 19 is an explanatory diagram illustrating an example of a display screen corresponding to at least one of the embodiments of the present disclosure; and

FIG. 20 is an explanatory diagram illustrating another example of the display screen corresponding to at least one of the embodiments of the present disclosure.

### DETAILED DESCRIPTION

Hereinafter, examples of embodiments according to the present disclosure will be described with reference to the drawings. Note that various components in the respective embodiments described below can be appropriately combined without any contradiction or the like. In addition, the description of the content described as a certain embodiment may be omitted in another embodiment. Further, the content of an operation or processing that does not relate to features of each of the embodiments may be omitted. Moreover, the order of various processes that constitute various flows described below may be changed without any contradiction or the like of processing content.

### First Embodiment

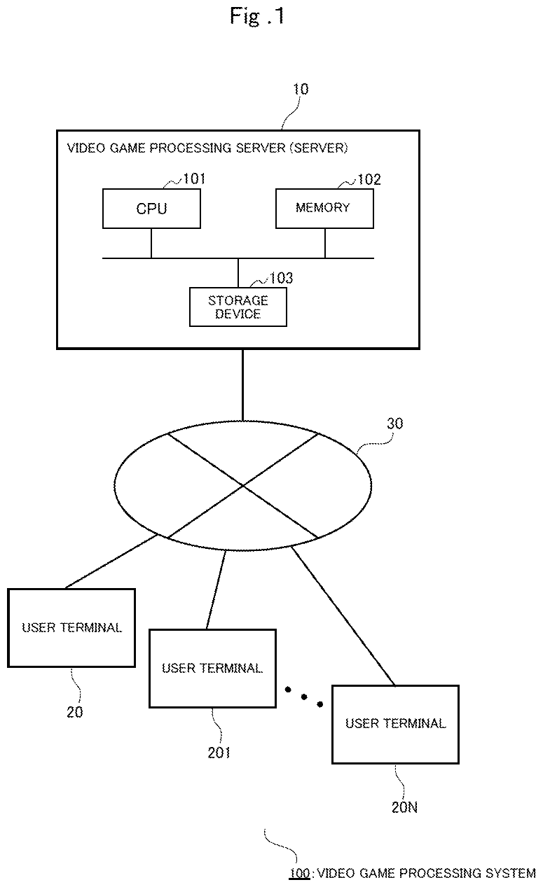

FIG. 1 is a block diagram illustrating an example of a configuration of a video game processing system 100 according to one embodiment of the present disclosure. As illustrated in FIG. 1, the video game processing system 100 includes a video game processing server 10 (hereinafter, referred to as a “server 10”) and user terminals 20, and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not illustrated in the drawings, the plurality of user terminals 20 and 201 to 20N is connected to the communication network 30 by executing data communication with base stations managed by a telecommunication carrier by means of a radio communication line.

The video game processing system 100 includes the server 10 and the plurality of user terminals 20 and 201 to 20N, whereby various kinds of functions for executing various kinds of processing in response to an operation of the user are performed.

The server 10 is managed by an administrator of the video game processing system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. A configuration of the server 10 is not limited particularly so long as the server 10 includes a general configuration for executing various kinds of processes as a computer, such as a control unit and a communication unit. Hereinafter, an example of a hardware configuration of the server 10 will be described briefly.

As illustrated in FIG. 1, the server 10 at least includes a CPU (Central Processing Unit) 101, a memory 102, and a storage device 103.

The CPU 101 is a central processing unit configured to execute various kinds of calculations and controls. Further, in a case where the server 10 includes a GPU (Graphics Processing Unit), a part of the various kinds of calculations and controls may be executed by the GPU. The server 10 appropriately executes, by the CPU 101, various kinds of information processing required to control a video game by using data read out onto the memory 102, and stores obtained processing results in the storage device 103 as needed.

The storage device 103 has a function as a storage medium for storing various kinds of information. A configuration of the storage device 103 is not limited particularly. However, it is preferable that the storage device 103 is configured so as to be capable of storing all of the various kinds of information required to control the video game from the viewpoint of reducing a processing load on each of the plurality of user terminals 20 and 201 to 20N. As such examples, there are an HDD and an SSD. However, a storage unit for storing the various kinds of information may be provided with a storage region in a state that the server 10 can access the storage region, for example, and may be configured so as to have a dedicated storage region outside the server 10.

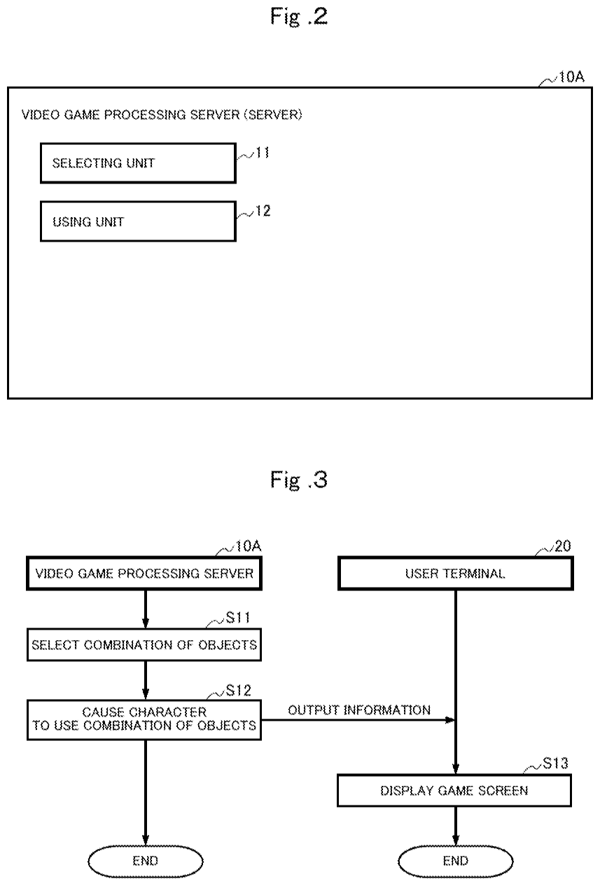

FIG. 2 is a block diagram illustrating a configuration of a video game processing server 10A (hereinafter, referred to as a “server 10A”), which is an example of the configuration of the server 10. As illustrated in FIG. 2, the server 10A at least includes a selecting unit 11 and a using unit 12.

The selecting unit 11 has a function to select a combination of objects, which are to be used for satisfying a predetermined condition (hereinafter, referred to as an “in-game condition”) in the video game, in accordance with a progress status of the video game.

Here, the phrase “in accordance with a progress status of the video game” means that a status of various kinds of progress or changes and the like that can be generated in the video game becomes timing or a standard of a specific process. As examples of the specific process, there are a determining process, an information updating process, and the like. Further, as examples of the status of the various kinds of progress or changes that can be generated in the video game, there are progress of time, a change in a game element value, a specific status or update of a flag, an operation input by the user, and the like.

Further, the in-game condition means a condition that is set in the video game. The in-game condition is not limited particularly. However, it is preferable that the in-game condition is a condition for causing the video game to proceed by a character. As examples of the in-game condition, there are a condition for causing a predetermined event to be completed or partially proceed, and a condition for completing a task given to the character. Timing when the in-game condition is set is not limited particularly. However, it is preferable that such timing is timing required for the character to cause the video game to proceed. In this regard, as examples of timing when a condition for causing the predetermined event to be completed or partially proceed, there are a time when the event is started, and predetermined timing during progress of the event. Further, as examples of the timing when the condition for completing the task given to the character is set, there are timing when the task is given to the character, and a time when the character is required to execute a predetermined action for completion of the task.

Further, the character means something that appears in the video game to take an action. The character includes something that takes an action on the basis of a user operation and something that autonomically takes an action regardless of a user operation. In particular, the character in the present embodiment is a character that autonomically takes an action regardless of a user operation. The character that autonomically takes an action is not limited particularly. Such a character may be a non-player character (NPC) that does not completely receive an operation of the user in the video game, or may be a character that receives an operation of the user in a partial status and does not receive an operation of the user in the other status. As an example of the character that autonomically takes an action, there is one that autonomically recognizes object(s) around it, and makes a decision to take an action against any object.

Further, the object means a virtual object that appears in the video game. In particular, each of the objects according to the present embodiment is used by the character for the purpose of carrying out a predetermined action. Here, the predetermined action is not limited particularly. However, the predetermined action may be an action targeting one object (for example, “throw”, “eat”, or “swing” an object), or may be an action targeting a plurality of objects (for example, “chop” or “hit” one object by using another object).

Further, the combination of the objects means one obtained by lumping a plurality of objects together. In particular, a specific action can be carried out by using the plurality of objects thus combined according to the present embodiment at the same time. Specifically, the phrase “at the same time” herein is a time when the plurality of objects is used at the same time, a period when the plurality of objects is used consecutively, a period when the plurality of objects is used discontinuously, and the like. Further, the specific action is not limited particularly. The specific action may be an action that can be carried out by using any of the combined objects alone, or an action that cannot be carried out even though each of the combined objects is used alone. As an example of the specific action, there is an action that targets a plurality of objects.

Further, a configuration to select the combination of the objects is not limited particularly. However, it is preferable that the combination of the objects is selected on the basis of information regarding the objects (hereinafter, referred to as “object information”). As an example of such a configuration, there is a configuration in which a combination of objects is selected on the basis of combination information in which plural kinds of object information are associated with each other. In this regard, the combination information is not limited particularly. However, it is preferable that information indicating an action, which can be carried out by using a plurality of combined objects at the same time, is also associated with the combination information.

The using unit 12 has a function to cause the character to use the combination of the objects selected by the selecting unit 11 in order to satisfy the in-game condition.

Here, timing when the character is caused to use the combination of the objects is not limited particularly. Various kinds of timing are conceivable so long as a combination of objects is selected. Namely, the timing when the character is caused to use the combination of the objects may be timing immediately after a selecting process of the combination, or may be required timing after the selecting process.

Each of the plurality of user terminals 20, and 201 to 20N is managed by the user, and is configured by a communication terminal capable of playing a network delivery type game, such as a cellular telephone terminal, a PDA (Personal Digital Assistants), a portable game apparatus, or a so-called wearable device, for example. In this regard, the configuration of the user terminal that the video game processing system 100 can include is not limited to the example described above. Each of the user terminals 20, and 201 to 20N may be configured so that the user can recognize the content of the video game. As the other examples of the user terminal, there are one obtained by combining various kinds of communication terminals, a personal computer, and a stationary game apparatus.

Further, each of the plurality of user terminals 20, and 201 to 20N is connected to the communication network 30, and includes hardware (for example, a display device for displaying a browser screen or a game screen based on a coordinate and the like) and software for executing various kinds of processes by communicating with the server 10A. In this regard, each of the plurality of user terminals 20, and 201 to 20N may be configured so as to be able to directly communicate with each other without the server 10A.

Next, an operation of the video game processing system 100 (hereinafter, referred to as the “system 100”) according to the present embodiment will be described.

FIG. 3 is a flowchart illustrating an example of game processing executed by the system 100. In the game processing according to the present embodiment, processes related to a control of progress of the video game in response to an operation of the user of the user terminal 20 (hereinafter, referred to as the “terminal 20”) are executed. Hereinafter, a case where the server 10A and the terminal 20 execute the game processing will be described as an example.

The game processing is started in a case where the terminal 20 displays an input screen for a condition, for example. Hereinafter, a case where a game condition is set and a plurality of objects is arranged in the terminal 20 will be described as an example.

In the game processing, the server 10A first selects a combination of objects, which are to be used for satisfying a predetermined condition (that is, an in-game condition) in the video game, in accordance with a progress status of the video game (Step S11). In the present embodiment, the server 10A selects a combination of a plurality of objects that allows a character to carry out a predetermined action by using the combination on the basis of object information at the same time.

When the combination of the objects is selected, the server 10A causes the character to use the selected combination of the objects in order to satisfy the in-game condition (Step S12). In the present embodiment, the server 10A causes the character to use the combination immediately after the selecting process of the combination to carry out the predetermined action. Further, the server 10A transmits, to the terminal 20, output information regarding the combination and the predetermined action.

When the output information is received from the server 10A, the terminal 20 outputs a game screen to a display screen of a predetermined display device (Step S13). In the present embodiment, when the terminal 20 outputs the game screen, the server 10A and the terminal 20 terminate the processes herein.

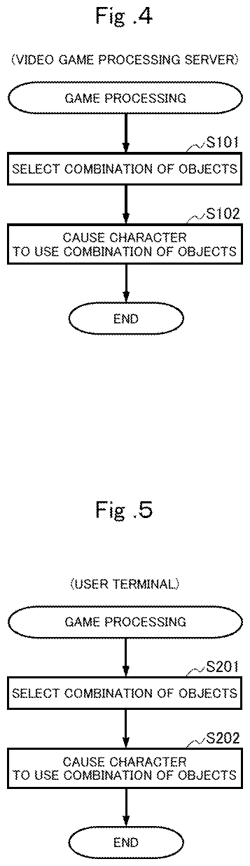

FIG. 4 is a flowchart illustrating an example of an operation of the server 10A side in the game processing. Here, an operation of the server 10A in the system 100 will be described again.

In the game processing, the server 10A first selects a combination of objects, which are to be used for satisfying a predetermined condition (that is, an in-game condition) in the video game, in accordance with a progress status of the video game (Step S101); and causes a character to use the selected combination of the objects in order to satisfy the in-game condition (Step S102). When the character is caused to use the combination of the objects, the server 10A terminates the processes herein.

FIG. 5 is a flowchart illustrating an example of the terminal 20 side in a case where the terminal 20 executes the game processing. Hereinafter, a case where the terminal 20 executes the game processing by a single body will be described as an example. In this regard, the configuration of the terminal 20 includes the similar functions to those of the server 10A except that the terminal 20 receives various kinds of information from the server 10A. For this reason, its explanation is omitted from a point of view to avoid repeated explanation.

In the game processing, the terminal 20 first selects a combination of objects, which are to be used for satisfying a predetermined condition (that is, an in-game condition) in the video game, in accordance with a progress status of the video game (Step S201); and causes a character to use the selected combination of the objects in order to satisfy the in-game condition (Step S202). When the character is caused to use the combination of the objects, the terminal 20 terminates the processes herein.

As explained above, as one side of the first embodiment, the server 10A that controls the character during progress of the video game is configured so as to at least include the selecting unit 11 and the using unit 12. Thus, the selecting unit 11 selects the combination of the objects, which are to be used for satisfying the predetermined condition (that is, the in-game condition) in the video game, in accordance with the progress status of the video game; and the using unit 12 causes the character to use the selected combination of the objects in order to satisfy the in-game condition. Therefore, it becomes possible to cause the action of the character for achieving a predetermined purpose in the video game to have the variety while suppressing the burden on developers from increasing.

Namely, it becomes possible to increase action patterns for causing the character to achieve the predetermined purpose while suppressing the burden on the developers regarding settings and management of data from increasing. Further, compared with a case where a character is allowed to use one object at a time, it becomes possible to realize complexity of the action of the character for achieving the purpose itself while suppressing the burden on the developers from increasing.

### Second Embodiment

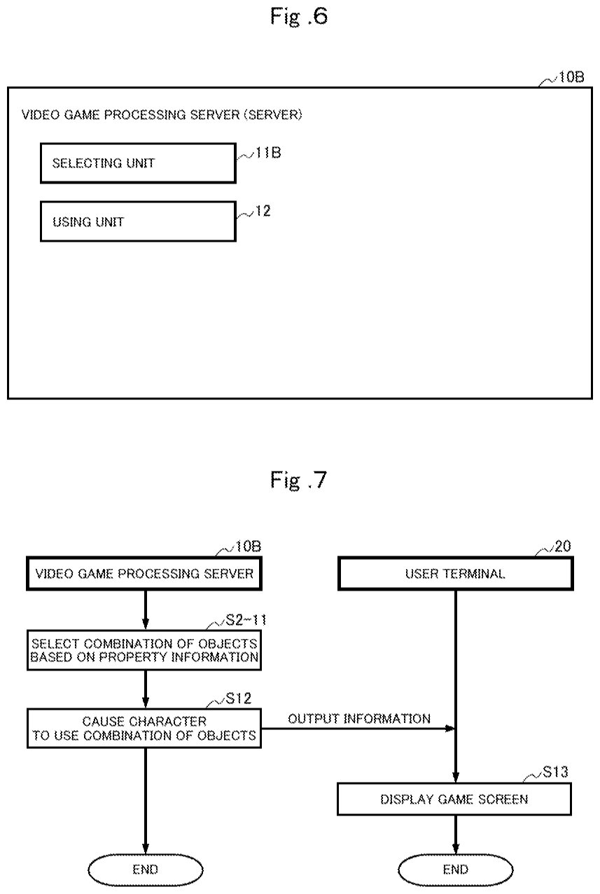

FIG. 6 is a block diagram illustrating a configuration of a video game processing server 10B (hereinafter, referred to as a “server 10B”), which is an example of the video game processing server 10. In the present embodiment, the server 10B at least includes a selecting unit 11B and a using unit 12.

The selecting unit 11B has a function to select a combination of objects, which are to be used for satisfying an in-game condition, on the basis of information that indicates a property set to each of the objects (hereinafter, referred to as “property information”).

Here, the property information means information that indicates a feature provided in an object. The property information is one example of the object information described in the first embodiment. The property of the object is not limited particularly. The property of the object may be a physical feature of the object, or may be one that directly indicates an action that can be carried out against the object. As examples of the information indicating a property, there are character string information indicating a property, identification information assigned to each property, and flag information corresponding to each property.

Further, the phrase “select a combination of objects on the basis of property information” means that a combination of objects is selected by referring to property information set to each object. A configuration to select the combination of the objects on the basis of the property information is not limited particularly. However, it is preferable that the selecting unit 11B is configured so as to select a combination of objects so that plural kinds of property information respectively set to a plurality of objects becomes a predetermined combination. As an example of such a configuration, there is a configuration in which a combination of objects is selected on the basis of property combination information in which plural kinds of property information and information indicating an action that can be carried out by the character are associated with each other.

FIG. 7 is a flowchart illustrating an example of game processing executed by a video game processing system 100. Hereinafter, operations of the server 10B and a user terminal 20 (hereinafter, referred to as a “terminal 20”) will be described as an example. In this regard, a flowchart illustrating an operation of each of the server 10B and the terminal 20 is omitted from a point of view to avoid repeated explanation.

In the game processing, the server 10B first selects a combination of objects, which are to be used for satisfying an in-game condition, on the basis of property information set to each of the objects during a progress status of a video game (Step S2-11). In the present embodiment, the server 10B selects a combination of objects so that property information set to each of the plurality of objects thus combined becomes a predetermined combination.

As explained above, as one side of the second embodiment, the server 10B that controls the character during progress of the video game is configured so as to at least include the selecting unit 11B and the using unit 12. Thus, the selecting unit 11B selects the combination of the objects, which are to be used for satisfying the in-game condition, on the basis of the information that indicates the property set to each of the objects (that is, the property information). Therefore, for example, compared with a case of referring to a type of the object itself, it becomes possible to cause the action of the character to have the variety by selecting the combination of the objects for achieving a predetermined purpose in the video game.

### Third Embodiment

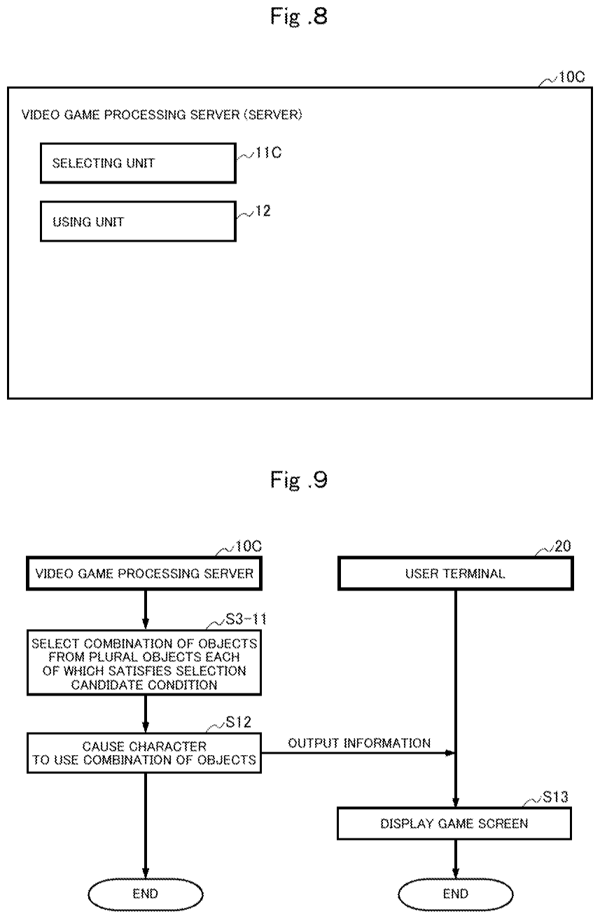

FIG. 8 is a block diagram illustrating a configuration of a video game processing server 10C (hereinafter, referred to as a “server 10C”), which is an example of the video game processing server 10. In the present embodiment, the server 10C at least includes a selecting unit 11C and a using unit 12.

The selecting unit 11C has a function to select a combination of objects, which are to be used for satisfying an in-game condition, from a plurality of objects each of which satisfies a selection candidate condition for objects regarding a character.

Here, the selection candidate condition for the objects regarding the character means a condition that one object becomes a candidate for a plurality of objects to be selected for use by the character. The selection candidate condition for the objects regarding the character is not limited particularly. However, it is preferable that the selection candidate condition is a condition for objects that is determined to be acquirable by the character. As examples of the condition for objects that is determined to be acquirable by the character, there are a condition that an object is arranged in the same predetermined area as that of a character or an area corresponding to a task given to the character, and a condition that an object is directly given to a character.

FIG. 9 is a flowchart illustrating an example of game processing executed by a video game processing system 100. Hereinafter, operations of the server 10C and a user terminal 20 (hereinafter, referred to as a “terminal 20”) will be described as an example. In this regard, a flowchart illustrating an operation of each of the server 10C and the terminal 20 is omitted from a point of view to avoid repeated explanation.

In the game processing, the server 10C first selects a combination of objects to be used for satisfying an in-game condition from a plurality of objects each of which satisfies a selection candidate condition for objects regarding a character in accordance with a progress status of a video game (Step S3-11). In the present embodiment, the server 10C selects a combination of objects to be used for satisfying an in-game condition from a plurality of objects arranged in an area corresponding to a task given to the character.

As explained above, as one side of the third embodiment, the server 10C that controls the character during progress of the video game is configured so as to at least include the selecting unit 11C and the using unit 12. Thus, the selecting unit 11C selects the combination of the objects to be used for satisfying the in-game condition from the plurality of objects each of which satisfies the selection candidate condition for the objects regarding the character in accordance with the progress status of the video game. Therefore, it becomes possible to easily manage data regarding the combination of the objects.

### Fourth Embodiment

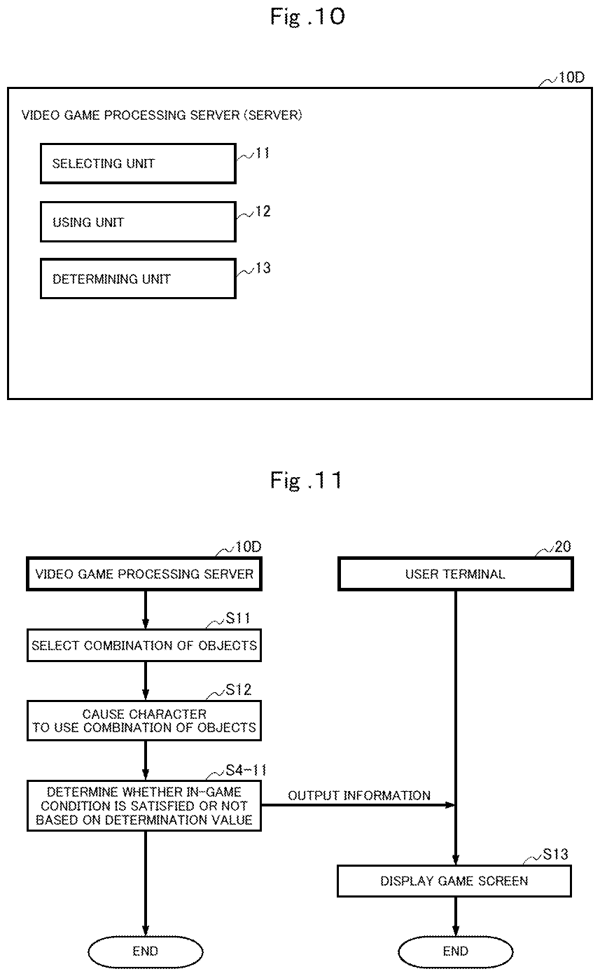

FIG. 10 is a block diagram illustrating a configuration of a video game processing server 10D (hereinafter, referred to as a “server 10D”), which is an example of the video game processing server 10. In the present embodiment, the server 10D at least includes a selecting unit 11, a using unit 12, and a determining unit 13.

The determining unit 13 has a function to determine whether an in-game condition is satisfied by using a combination by the using unit 12 or not on the basis of a predetermined determination value.

Here, the determination value means a value that is used for determining whether an in-game condition is satisfied or not. The determination value is not limited particularly. The determination value may be a value regarding a plurality of objects that are combined and used, or may be a value regarding a character. As examples of the value regarding the object, there are durability, a size and weight of an item. As examples of the value regarding the character, there are arm strength and foot strength of the character.

Further, the phrase “determine on the basis of the predetermined determination value” means determination based on whether a predetermined determination value is a value within a predetermined range or not or whether the predetermined determination value is a predetermined value or not. A configuration to determine on the basis of the predetermined determination value is not limited particularly. The determining unit 13 may be configured so as to determine it on the basis of one determination value, or may be configured so as to determine it on the basis of two or more determination values. As an example of the configuration to determine it on the basis of two or more determination values, there is a configuration in which it is determined on the basis of whether two or more determination values are respectively values within corresponding predetermined ranges or not.

FIG. 11 is a flowchart illustrating an example of game processing executed by a video game processing system 100. Hereinafter, operations of the server 10D and a user terminal 20 (hereinafter, referred to as a “terminal 20”) will be described as an example. In this regard, a flowchart illustrating an operation of each of the server 10D and the terminal 20 is omitted from a point of view to avoid repeated explanation.

When a character is caused to use a combination of objects, the server 10D determines whether an in-game condition is satisfied by using the combination of the objects or not on the basis of a predetermined determination value (Step S4-11). In the present embodiment, the server 10D determines whether the in-game condition is satisfied or not on the basis of whether two or more determination values regarding the plurality of objects thus combined are respectively values within corresponding predetermined ranges or not. Further, the server 10D transmits, to the terminal 20, output information regarding a determination result in addition to the output information regarding the combination and the predetermined action (see Step S12 of the first embodiment).

As explained above, as one side of the fourth embodiment, the server 10D that controls the character during progress of the video game is configured so as to at least include the selecting unit 11, the using unit 12, and the determining unit 13. Thus, the determining unit 13 determines whether the in-game condition is satisfied by using the combination of the objects or not on the basis of the predetermined determination value. Therefore, it is possible to execute more detailed determining process with respect to a result using the combination of the objects compared with a case where the determination value is not used, and this makes it possible to improve a game balance.

### Fifth Embodiment

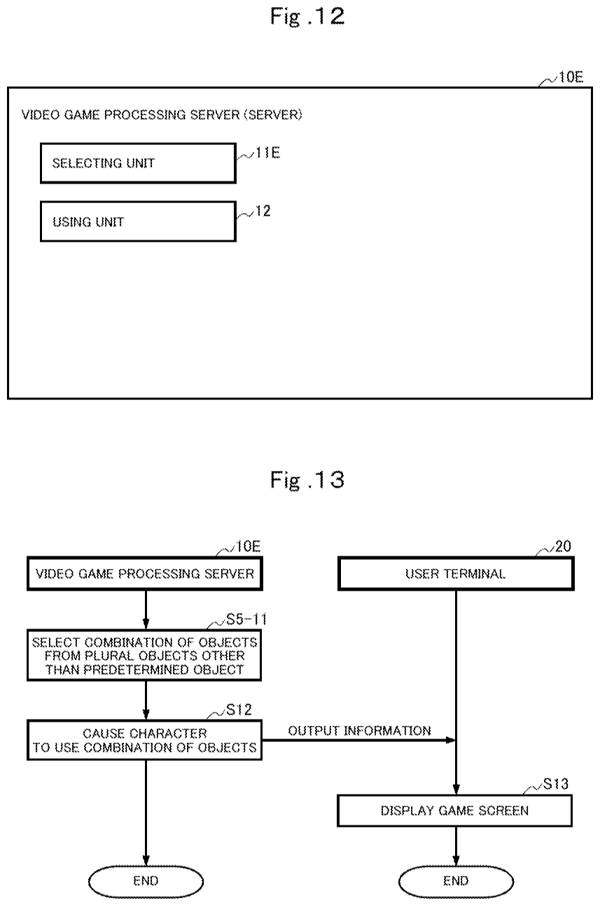

FIG. 12 is a block diagram illustrating a configuration of a video game processing server 10E (hereinafter, referred to as a “server 10E”), which is an example of the video game processing server 10. In the present embodiment, the server 10E at least includes a selecting unit 11E and a using unit 12.

The selecting unit 11E has a function to select a combination of objects, which are to be used for satisfying an in-game condition, from a plurality of objects other than a predetermined object on the basis of information indicating an action of a character associated with the predetermined object.

Here, the information indicating the action of the character means information indicating an action that the character can carry out by using the predetermined object. The information indicating the action of the character is not limited particularly. However, it is preferable that the information is information indicating an action that a character can carry out by using a predetermined object by a single body. As an example of the information indicating the action of the character, there is information indicating a type of an action of a character.

Further, a configuration to select the combination of the objects from the plurality of objects other than the predetermined object is not limited particularly. However, such a configuration may be a configuration in which on the basis of information indicating an action of a character associated with a predetermined object, a combination of objects, which allows the same type of action as the action by usage thereof, is selected.

FIG. 13 is a flowchart illustrating an example of game processing executed by a video game processing system 100. Hereinafter, operations of the server 10E and a user terminal 20 (hereinafter, referred to as a “terminal 20”) will be described as an example. In this regard, a flowchart illustrating an operation of each of the server 10E and the terminal 20 is omitted from a point of view to avoid repeated explanation.

In the game processing, the server 10E first selects a combination of objects, which are to be used for satisfying an in-game condition, from a plurality of objects other than a predetermined object on the basis of information indicating an action of a character associated with the predetermined object (Step S5-11). In the present embodiment, the server 10E selects, on the basis of information indicating an action of a character associated with a predetermined object, a combination of objects, which allows the same type of action as the action by usage thereof.

As explained above, as one side of the fifth embodiment, the server 10E that controls the character during progress of the video game is configured so as to at least include the selecting unit 11E and the using unit 12. Thus, the selecting unit 11E selects the combination of the objects, which are to be used for satisfying the in-game condition, from the plurality of objects other than the predetermined object on the basis of the information indicating the action of the character associated with the predetermined object. Therefore, it becomes possible to reduce the burden of setting of an action for objects.

### Sixth Embodiment

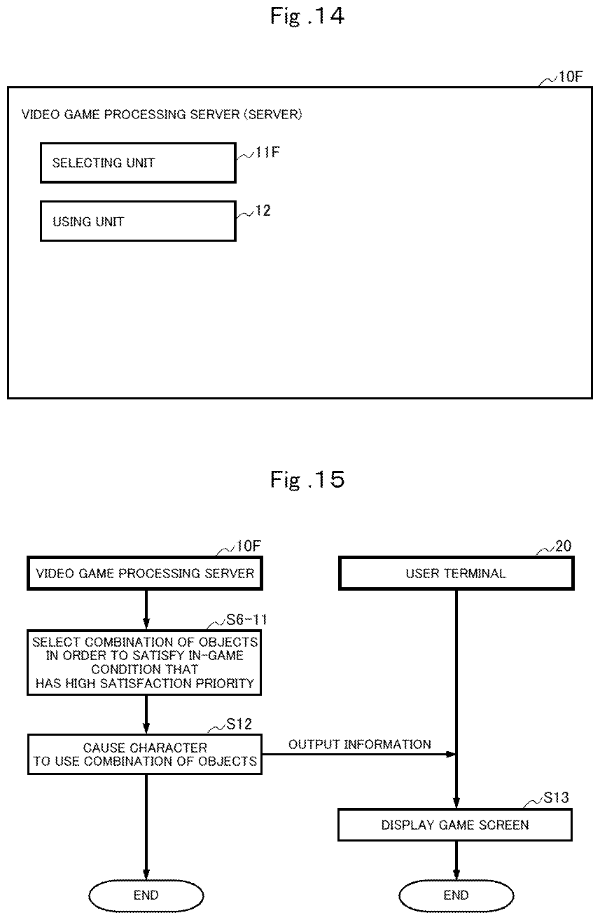

FIG. 14 is a block diagram illustrating a configuration of a video game processing server 10F (hereinafter, referred to as a “server 10F”), which is an example of the video game processing server 10. In the present embodiment, the server 10F at least includes a selecting unit 11F and a using unit 12.

The selecting unit 11F has a function to preferentially select a combination of objects to be used for satisfying another in-game condition when such another in-game condition whose satisfaction priority is higher than that of an in-game condition is set before the in-game condition is satisfied.

Here, the satisfaction priority of the in-game condition means a degree of priority that the in-game condition is satisfied. The satisfaction priority of the in-game condition is not limited particularly. The satisfaction priority of the in-game condition may be based on an order of a plurality of in-game conditions, or may be set as a value for each in-game condition. A configuration to set a satisfaction priority of an in-game condition is not limited particularly. However, it is preferable that the selecting unit 11F is configured so as to set the satisfaction priority on the basis of a progress status of a video game or another in-game condition. As an example of the configuration to set the satisfaction priority of the in-game condition, there is a configuration in which in a case where it is necessary to satisfy other in-game condition in order to satisfy a specific in-game condition, a satisfaction priority of the other in-game condition is set to be higher than a satisfaction priority of the specific in-game condition.

Further, the phrase “preferentially select a combination of objects to be used for satisfying a specific in-game condition” means that a combination of objects to be used for satisfying a specific in-game condition is selected prior to a combination of objects to be used for satisfying the other in-game condition. A configuration to preferentially select a combination of objects to be used for satisfying a specific in-game condition is not limited particularly. Such a configuration may be a configuration in which a plurality of objects that have already been selected and combined is included as selection candidates, or may be a configuration in which the plurality of objects is not included as the selection candidates.

Further, timing when the combination of the objects is preferentially selected is not limited particularly. Such timing may be timing immediately after a process of setting an in-game condition whose satisfaction priority is higher than those of in-game conditions that have already been set, or may be timing required timing after the process of setting.

FIG. 15 is a flowchart illustrating an example of game processing executed by a video game processing system 100. Hereinafter, operations of the server 10F and a user terminal 20 (hereinafter, referred to as a “terminal 20”) will be described as an example. In this regard, a flowchart illustrating an operation of each of the server 10F and the terminal 20 is omitted from a point of view to avoid repeated explanation.

In the game processing, the server 10F first selects a combination of objects to be used for satisfying another in-game condition preferentially when such another in-game condition whose satisfaction priority is higher than that of an in-game condition is set before the in-game condition is satisfied (Step S6-11). In the present embodiment, the server 10F preferentially selects a combination of objects to be used for satisfying another in-game condition, which is included in a plurality of objects that have already been selected and combined as selection candidates and whose satisfaction priority is higher than that of the in-game condition.

As explained above, as one side of the sixth embodiment, the server 10F that controls the character during progress of the video game is configured so as to at least include the selecting unit 11F and the using unit 12. Thus, the selecting unit 11F preferentially selects the combination of the objects to be used for satisfying another in-game condition when such another in-game condition whose satisfaction priority is higher than that of the in-game condition is set before the in-game condition is satisfied. Therefore, it becomes possible to cause the character to carry out the action according to a change in a situation, and this makes it possible to improve the taste of the video game regarding control of the character.

### Seventh Embodiment

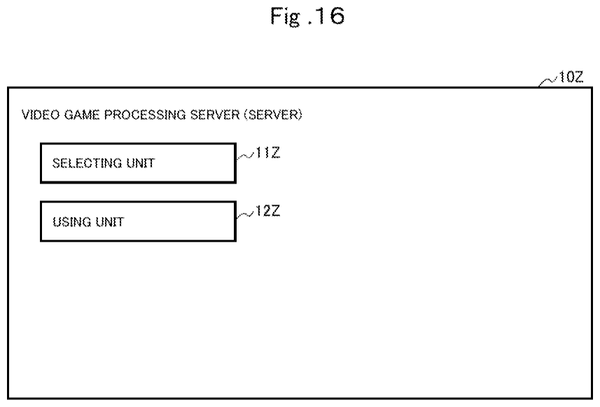

FIG. 16 is a block diagram illustrating a configuration of a video game processing server 10Z (hereinafter, referred to as a “server 10Z”), which is an example of the video game processing server 10 in the video game processing system 100 (see FIG. 1). In the present embodiment, the server 10Z at least includes a selecting unit 11Z and a using unit 12Z.

The selecting unit 11Z has a function to select a combination of objects, which are to be used for satisfying a predetermined condition (hereinafter, referred to as an “in-game condition”) in a video game, in accordance with a progress status of the video game.

Here, the phrase “in accordance with a progress status of the video game” means that a status of various kinds of progress or changes and the like that can be generated in the video game becomes timing or a standard of a specific process. Hereinafter, a case where a character is controlled in accordance with the progress status of the video game by the character will be described as an example.

Further, the in-game condition means a condition that is set in the video game. Hereinafter, a case where the in-game condition is a condition for achieving a purpose set to the character will be described as an example. As examples of the condition for achieving the purpose set to the character, there are a condition “light up” in a case where a task to explore a dungeon with poor visibility due to lack of light is set to a character, and a condition “cutting a rope” in a case where a task to acquire luggage hung on the rope is set to a character. Further, as other examples of the condition described above, there are a condition “move an item A to a get-at-able place” in a case where a task to acquire a specific item A is set to a character, and a condition “a user himself or herself moves to a get-at-able place” in a case where a task to press a switch at an un-get-at-able place is set to a character. Further, as still other examples of the condition described above, there are a condition “destroy a wall” in a case where a task to move to the other side of a wall is set to a character, and a condition “place an object on a switch” in a case where a task to keep a switch in a pressed state is set to a character.

Further, the character means something that appears in the video game to take an action. The character includes something that takes an action on the basis of a user operation and something that autonomically takes an action regardless of a user operation. In particular, the character in the present embodiment is a character that autonomically takes an action regardless of a user operation. The character that autonomically takes an action is not limited particularly. Such a character may be a non-player character (NPC) that does not completely receive an operation of the user in the video game, or may be a character that receives an operation of the user in a partial status and does not receive an operation of the user in the other status. Hereinafter, a case where the character is an NPC will be described as an example. In the present embodiment, the NRC recognizes an object in the video game, and makes a decision to carry out an action. The phrase “make a decision” herein means that a concrete action to be carried out by the NRC is determined.

Further, the object means a virtual object that appears in the video game. In particular, each of the objects according to the present embodiment is used by the character for the purpose of carrying out a predetermined action. Hereinafter, a case where an object is an item such as a sword, a torch, or a ball will be described as an example. Here, the predetermined action is not limited particularly. However, the predetermined action may be an action targeting one object (for example, “throw”, “eat”, or “swing” an object, or “light up”), or may be an action targeting a plurality of objects (for example, “chop” or “hit” one object by using another object).

Further, the combination of the objects means one obtained by lumping a plurality of objects together. In particular, a specific action can be carried out by using the plurality of objects thus combined according to the present embodiment at the same time. Specifically, the phrase “at the same time” herein is a time when the plurality of objects is used at the same time, a period when the plurality of objects is used consecutively, a period when the plurality of objects is used discontinuously, and the like. For example, in a case where a plurality of objects thus combined is a torch and a lighter, a specific action that can be carried out by using them at the same time is that fire is generated by the lighter to ignite the torch.

Further, a configuration to select the combination of the objects is not limited particularly. However, it is preferable that the combination of the objects is selected on the basis of information regarding the objects (hereinafter, referred to as “object information”). Hereinafter, a case where a combination of objects to be used for satisfying an in-game condition is selected on the basis of information indicating a property set to each of the objects (that is, property information) will be described as an example. Here, the property information means information indicating a feature provided in an object. The property of the object is not limited particularly. The property of the object may be a physical feature of the object (for example, “elongated”, or “burn”), or may be one that directly indicates an action that can be carried out against the object (for example, “swing”, “kick”, or “throw”).

Further, in the present embodiment, in a case where a character enters an area corresponding to a predetermined event, an in-game condition for causing the event to proceed is set. After the in-game condition is set, a plurality of objects for satisfying the in-game condition (objects as selection candidates) is arranged in an area corresponding to the predetermined event. Timing when the objects are arranged is not limited particularly. Such timing may be timing immediately after the in-game condition is set, or may be timing after a process of specifying an action of a character for satisfying the in-game condition is executed for a predetermined time. The combination of the objects to be used by the character is selected from the plurality of objects arranged in the area corresponding to the predetermined event. The type and the number of objects to be arranged are determined appropriately. In this regard, a process of arranging the objects may be executed on the basis of a user operation. Further, additional object(s) may further be arranged even after the objects have been arranged once.

Further, in the present embodiment, in a case where another in-game condition whose satisfaction priority is higher than that of the in-game condition, which has already been set, is set, a combination of objects to be used for satisfying such another in-game condition is preferentially selected (that is, replanning is executed). Here, the satisfaction priority of the in-game condition means a degree of priority that the in-game condition is satisfied. Specifically, in a case where it is necessary to satisfy another in-game condition for satisfying the in-game condition that has already been set, a combination of objects to be used for satisfying such another in-game condition is preferentially selected.

For example, in a case where an obstacle appears between a character and a specific item in a situation where an in-game condition to “obtain a specific item” has already been set and it is necessary for the character to destroy the obstacle in order to obtain the specific item, a satisfaction priority of an in-game condition to “destroy an obstacle” is set to be higher than that of the in-game condition to “obtain a specific item”. For this reason, the combination of the objects to be used for satisfying the in-game condition to “destroy an obstacle” is first selected. Here, the plurality of objects that are combined to be used for satisfying the in-game condition to “obtain a specific item” may be selected in the selection of the combination to be used for satisfying the in-game condition to “destroy an obstacle”.

Further, the selecting unit 11Z has a function to select a combination of objects that is to be used for satisfying an in-game condition by using goal orientation planning. Here, the goal orientation planning means that a goal is determined and actions (or processes) required to achieve the goal are combined on the basis of a progress status of a video game. As an example of the goal orientation planning, there is GOAP (Goal Oriented Action Planning). By using the goal orientation planning to select a combination of objects, it becomes possible to improve efficiency of a selecting process of the combination of the objects and ease of work such as debugging at a development stage.

The using unit 12Z has a function to cause the character to use the combination of the objects selected by the selecting unit 11Z in order to satisfy the in-game condition.

Here, timing when the character is caused to use the combination of the objects is not limited particularly. Various kinds of timing are conceivable so long as a combination of objects is selected. Namely, the timing when the character is caused to use the combination of the objects may be timing immediately after a selecting process of the combination, or may be required timing after the selecting process.

In this regard, it is determined whether the in-game condition is satisfied by using the plurality of objects thus combined at the same time or not in accordance with a predetermined criterion. In the present embodiment, as an example of a configuration of the determination in accordance with the predetermined criterion, there is a configuration in which it is determined on the basis of a predetermined determination value. Here, the determination value means a value that is used for determining whether an in-game condition is satisfied or not. As examples of the determination value, there are durability, a size and weight of an item. As examples of a value regarding the character, there are arm strength and foot strength of the character. For example, in a case where a combination of a wooden stick and a ball is selected and a character is caused to carry out an action to hit and fly the ball with the wooden stick, the ball is successfully flied if weight of the wooden stick is a predetermined value or heavier. Further, in another example, in a case where a character is caused to carry out an action to generate fire by a lighter to ignite a torch, it succeeds in igniting the torch if a predetermined amount or more of fuel remains in the lighter.

Further, the server 102 may be configured so as to select a combination of objects to be used for satisfying an in-game condition from a plurality of objects other than a predetermined object on the basis of information indicating an action of the character associated with the predetermined object. Here, the information indicating the action of the character means information indicating an action that can be carried out by using the predetermined object.

Further, the plurality of objects other than the predetermined object may include an object that has a predetermined relationship with the predetermined object. Here, as examples of the object that has the predetermined relationship with the predetermined object, there are an object that has a relationship capable of inheriting information regarding an action with the predetermined object, and an object that can realize a property similar to a property of the predetermined object by using it in combination with another object. As examples of the object that has a relationship capable of inheriting information regarding an action with the predetermined object, there are an object that has an approximate relationship with the predetermined object, and an object that has a parameter similar to a predetermined parameter (for example, a shape parameter and a weight parameter) of the predetermined object. As an example of a configuration to realize the property similar to the property of the predetermined object by using a plurality of objects thus combined, there is a configuration in which a specific function can be exerted in the similar manner to the predetermined object by using a plurality of objects thus combined. For example, in a case where the predetermined object is a “sword”, a “sword blade” and a “thick cloth” are combined with each other, and the character can attack an enemy without damaging a hand of the character in the similar manner to the “sword” by wrapping the “thick cloth” around the “sword blade”. In this regard, the “without damaging” herein is a function that is exerted when the “sword” is used. The “thick cloth” herein may be “metal artificial hand” instead, for example, (without injury).

In this regard, the information indicating the action of the character described above is one example of information indicating a motion of the character. Here, the motion of the character means that the character moves. The motion of the character is not limited particularly. However, it is preferable that the motion is related to an object. Any motion of a body of the character may be included in the motion of the character in addition to the action of the character.

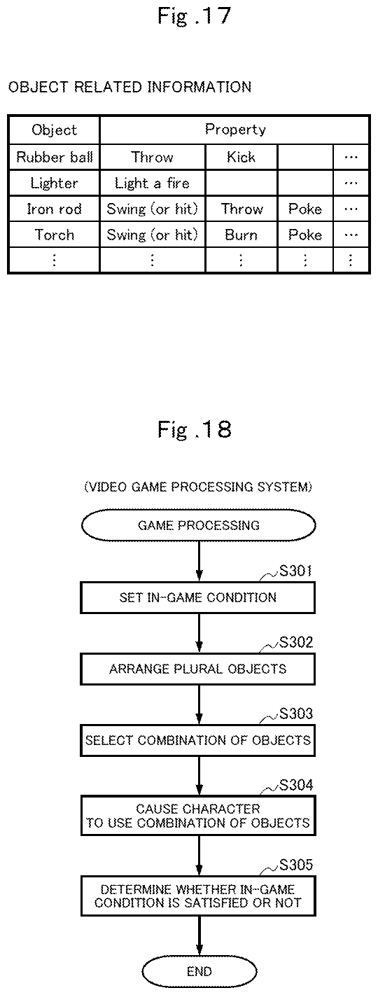

FIG. 17 is an explanatory table for explaining an example of a storage state of information stored in a storage unit (not illustrated in the drawings) included in the server 10Z. As illustrated in FIG. 17, objects as information regarding objects and properties are stored in the storage unit so as to be associated with each other as object related information.

The object means information indicating a name of the object.

The property means information indicating a property set to the object (hereinafter, referred to as “property information”). In the present embodiment, the property information is information in which the property set to the object is indicated by a character string. Here, with respect to information indicating the similar action of the property information, a plurality of properties may be indicated as one piece of property information. In the present embodiment, “swing” and “hit” are set to property information of objects “iron rod” and “torch” as one piece of property information “swing (or hit)”. The “swing” herein indicates an action that targets a single body of the “iron rod” or the “torch”. On the other hand, the “hit” indicates an action that targets a plurality of objects such as a combination of the “iron rod” or “torch” and another object (for example, a “rubber ball”).

In this regard, the object related information in which the object and the property are associated with each other has been described in FIG. 17. However, at least a part of the objects with which the predetermined parameter is further associated may be stored in the storage unit as the object related information.

Next, an operation of a video game processing system 100Z (hereinafter, referred to as a “system 100Z”; not illustrated in the drawings), which is an example of the video game processing system 100 (see FIG. 1), will be described. The system 100Z includes the server 10Z. Hereinafter, in order to simplify explanation thereof, a case where the system 100Z executes processes executed by any of the server 10Z and a user terminal 20 (hereinafter, referred to as a “terminal 20”) will be described.

FIG. 18 is a flowchart illustrating an example of game processing executed by the system 100Z. In the game processing according to the present embodiment, processes related to control the character during progress of the video game are executed. Hereinafter, each of the processes will be described. In this regard, the order of the processes may be changed without any contradiction or the like of processing content.

The game processing is started as an opportunity that the terminal 20 accesses the server 10Z to request display of a game screen, for example.

In the game processing, the system 100Z first sets an in-game condition (Step S301). In the present embodiment, the system 100Z sets an in-game condition for causing an event to proceed in a case where a character enters an area corresponding to a predetermined event.

When the in-game condition is set, the system 100Z arranges a plurality of objects (Step S302). In the present embodiment, the system 100Z arranges a plurality of objects for satisfying the in-game condition in an area corresponding to the predetermined event.

When the plurality of objects is arranged, the system 100Z selects a combination of objects to be used for satisfying the in-game condition in accordance with a progress status of the video game (Step S303). In the present embodiment, the system 100Z selects a combination of objects on the basis of property information set to each object.

When the combination of the objects is selected, the system 100Z causes the character to use the selected combination of the objects in order to satisfy the in-game condition (Step S304). In the present embodiment, the system 100Z causes the character to use the combination immediately after the selecting process of the combination of the objects.

When the character is caused to use the combination of the objects, the system 100Z determines whether the in-game condition is satisfied by using the plurality of combined objects at the same time or not on the basis of a predetermined criterion (Step S305). In the present embodiment, the system 100Z determines whether the in-game condition is satisfied by using the plurality of combined objects at the same time or not on the basis of a predetermined determination value.

In the present embodiment, after it is determined whether the in-game condition is satisfied or not, the system 100Z terminates the processes herein.

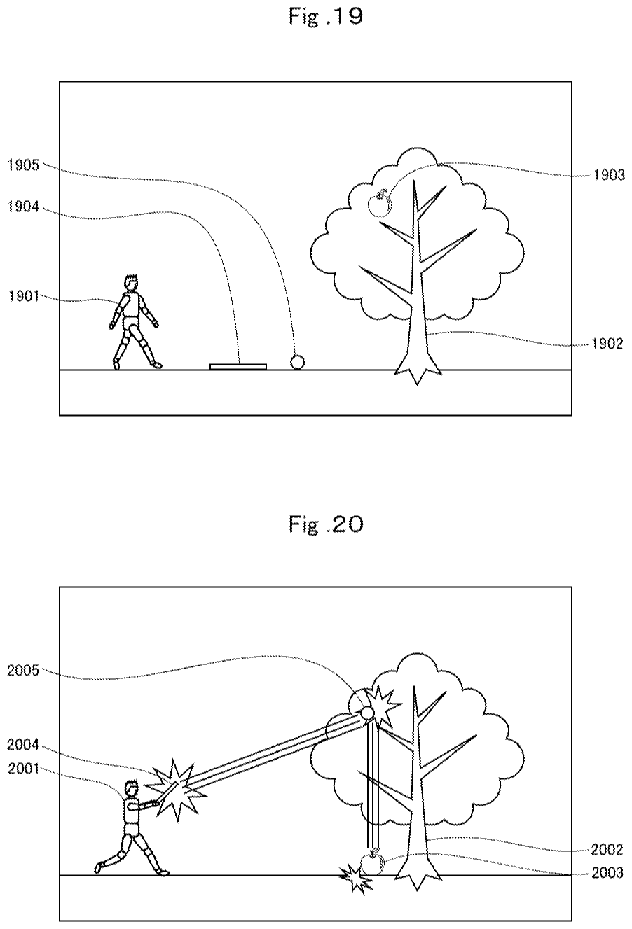

FIG. 19 is an explanatory diagram for explaining an example of a game screen. A character 1901 of a user, a tree 1902, an apple 1903, an iron rod 1904, and a ball 1905 are illustrated on the game screen of FIG. 19.

The character 1901 is a character that autonomously recognizes and uses an object. The tree 1902 is an object that is generated in a virtual space. The apple 1903 is an object that is arranged on the tree 1902. The iron rod 1904 and the ball 1905 are objects that are arranged in the vicinity of the character 1901. In the example illustrated in FIG. 19, the game screen immediately after an in-game condition of acquiring the apple 1903 on the tree 1902 is set is illustrated. Here, the in-game condition thus set is used for the character 1901 to cause the video game to proceed. In this regard, in the present embodiment, the apple 1903 is an object that cannot be acquired even though a character uses any of the iron rod 1904 and the ball 1905.

FIG. 20 is an explanatory diagram for explaining another example of the game screen. A character 2001 of a user, a tree 2002, an apple 2003, an iron rod 2004, and a ball 2005 are illustrated on the game screen of FIG. 20. The character 2001 to the ball 2005 respectively correspond to the character 1901 to the ball 1905 illustrated in FIG. 19.

Here, as illustrated in FIG. 20, the character 2001 uses a combination of the iron rod 2004 and the ball 2005. Specifically, the character 2001 swings the iron rod 2004 to hit (or drive) the ball 2005. As a result, the ball 2005 comes into collision with the apple 2003, whereby the apple 2003 falls to the ground due to the collision. For that reason, the character 2001 is in a situation where the character 2001 can acquire the apple 2003.

As explained above, as one side of the seventh embodiment, the server 10Z that controls the character during progress of the video game is configured so as to at least include the selecting unit 11Z and the using unit 12Z. Thus, the selecting unit 11Z selects the combination of the objects (for example, items), which are to be used for satisfying the predetermined condition (that is, the in-game condition) in the video game, in accordance with the progress status of the video game; and the using unit 12Z causes the character to use the selected combination of the objects (for example, causes the character to carry out an action) in order to satisfy the in-game condition. Therefore, it becomes possible to cause the action of the character for achieving a predetermined purpose in the video game to have the variety while suppressing the burden on developers from increasing.

Namely, it becomes possible to increase action patterns for causing the character to achieve the predetermined purpose while suppressing the burden on the developers regarding settings and management of data from increasing. Further, compared with a case where a character is allowed to use one object at a time, it becomes possible to realize complexity of the action of the character for achieving the purpose itself while suppressing the burden on the developers from increasing.

Further, in the example of the seventh embodiment described above, the server 10Z is configured so as to select a combination of objects to be used for satisfying an in-game condition on the basis of information indicating a property set to each of objects (property information). For example, compared with a case of referring to a type of the object itself, it becomes possible to cause selection of the combination of the objects for achieving a predetermined purpose in the video game further to have the variety.

Further, in the example of the seventh embodiment described above, the server 10Z is configured so as to select a combination of objects to be used for satisfying an in-game condition from a plurality of objects each of which satisfies a selection candidate condition for the objects regarding a character. Therefore, it becomes possible to easily manage data regarding the combination of the objects.

Further, in the example of the seventh embodiment described above, the server 10Z is configured to determine whether the in-game condition is satisfied by usage of the combination or not on the basis of the predetermined determination value. Therefore, it is possible to execute more detailed determining process with respect to a result using the combination of the objects compared with a case where the determination value is not used, and this makes it possible to improve a game balance.

Further, in the example of the seventh embodiment described above, the server 10Z is configured so as to select a combination of objects, which are to be used for satisfying an in-game condition, from a plurality of objects other than a predetermined object on the basis of information indicating an action of a character associated with the predetermined object. Therefore, it becomes possible to reduce the burden of setting of an action for objects.

Further, in the example of the seventh embodiment described above, the server 10Z is configured so as to select a combination of objects to be used for satisfying another in-game condition when such another in-game condition whose satisfaction priority is higher than that of an in-game condition is set before the in-game condition is satisfied. Therefore, it becomes possible to cause the character to carry out the action according to a change in a situation, and this makes it possible to improve the taste of the video game regarding control of the character.

In this regard, it has not been mentioned particularly in the example of the seventh embodiment described above. However, the server 10Z may be configured so as to control a first object during progress of any task. The “first object” herein is a replacement of the “character” in the example of the seventh embodiment. Further, the server 10Z may be configured so as to: select a combination of second objects to be used for satisfying a predetermined condition regarding a task (that is, a task condition) in accordance with a progress status of any task; and cause the first object to use the selected combination of the second objects in order to satisfy the task condition. Here, the “second object” is a replacement of the “object” in the example of the seventh embodiment. Further, the task means an individual work or step, an execution unit of a process, or the like.

As explained above, one shortage or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, and 201 to 20N and the server 10 executes the various kinds of processing described above in accordance with various kinds of control programs (for example, a video game processing program) stored in the storage device with which the corresponding terminal or server is provided.

Further, the configuration of the video game processing system 100 is not limited to the configuration that has been explained as an example of each of the embodiments described above. For example, the system 100 may be configured so that the server 10 executes a part or all of the processes that have been explained as the processes executed by the user terminal 20. Alternatively, the system 100 may be configured so that any of the plurality of user terminals 20, and 201 to 20N (for example, the user terminal 20) executes a part or all of the processes that have been explained as the processes executed by the server 10. Further, the system 100 may be configured so that a part or all of the storage unit included in the server 10 is included in any of the plurality of user terminals 20, and 201 to 20N. Namely, the system 100 may be configured so that a part or all of the functions of any one of the user terminal 20 and the server 10 according to the system 100 is included in the other.

Further, the system 100 may be configured so that the program causes a single apparatus to perform a part or all of the functions that have been explained as the example of each of the embodiments described above without including a communication network.

(Appendix)

The explanation of the embodiments described above has been described so that the following disclosures can be at least performed by a person having a normal skill in the art to which the present disclosure belongs.

(1)

A non-transitory computer-readable medium including a video game processing program for causing a server to perform functions to control a character during progress of a video game, the functions comprising:

a selecting function configured to select a combination of objects in accordance with a progress status of the video game, the objects being to be used for satisfying a predetermined condition in the video game as an in-game condition; and

an using function configured to cause the character to use the combination of the objects selected by the selecting function in order to satisfy the in-game condition.

(2)

The non-transitory computer-readable medium according to (1),

wherein the selecting function includes a function configured to select a combination of objects on a basis of information indicating a property set to each of the objects as property information, the objects being to be used for satisfying the in-game condition.

(2-1)

The non-transitory computer-readable medium according to (2),

wherein the selecting function includes a function configured to select the combination of the objects on the basis of the property information so that the character is allowed to carry out a predetermined action for satisfying the in-game condition.

(3)

The non-transitory computer-readable medium according to (1) or (2),

wherein the selecting function includes a function configured to select the combination of the objects to be used for satisfying the in-game condition from a plurality of objects, each of the plurality of objects satisfying a selection candidate condition of objects regarding the character.

(4)

The non-transitory computer-readable medium according to any one of (1) to (3), the functions further comprising:

a determining function configured to determine whether the in-game condition is satisfied by using the combination by the using function or not on a basis of a predetermined determination value.

(5)

The non-transitory computer-readable medium according to any one of (1) to (4),

wherein the selecting function includes a function configured to select the combination of the objects to be used for satisfying the in-game condition from a plurality of objects other than a predetermined object on a basis of information indicating an action of a character associated with the predetermined object.

(5-1)

The non-transitory computer-readable medium according to (5),

wherein the plurality of objects other than the predetermined object includes an object that has a predetermined relationship with the predetermined object.

(6)

The non-transitory computer-readable medium according to any one of (1) to (5),

wherein the selecting function includes a function configured to preferentially select a combination of objects to be used for satisfying an other in-game condition when the other in-game condition is set before the in-game condition is satisfied, the other in-game condition having a higher satisfaction priority than that of the in-game condition.

(7)

The non-transitory computer-readable medium according to any one of (1) to (6),

wherein the selecting function includes a function configured to select the combination of the objects to be used for satisfying the in-game condition by using goal orientation planning.

(8)

A non-transitory computer-readable medium including a video game processing program for causing a user terminal to perform at least one function of the functions that the video game processing program described in any one of (1) to (7) causes the server to perform, the user terminal being capable of communicating with the server.

(9)

A video game processing system for controlling progress of a video game in response to an operation of a user, the video game processing system comprising a communication network, a server, and a user terminal, the video game processing system further comprising:

a selector configured to select a combination of objects in accordance with a progress status of the video game, the objects being to be used for satisfying a predetermined condition in the video game as an in-game condition; and

a usage controller configured to cause a character to use the combination of the objects selected by the selector in order to satisfy the in-game condition.

(10)

The video game processing system according to (9),

wherein the server includes the selector and the usage controller, and

wherein the user terminal includes an output controller configured to output a game screen to a display screen of a display device, the game screen indicating a state of the character.

(11)

A non-transitory computer-readable medium including a video game processing program for causing a user terminal to perform functions to control progress of a video game in response to an operation of a user, the functions comprising:

a selecting function configured to select a combination of objects in accordance with a progress status of the video game, the objects being to be used for satisfying a predetermined condition in the video game as an in-game condition; and

a using function configured to cause a character to use the combination of the objects selected by the selecting function in order to satisfy the in-game condition.

(12)

A video game processing method of controlling progress of a video game in response to an operation of a user, the video game processing method comprising:

a selecting process configured to select a combination of objects in accordance with a progress status of the video game, the objects being to be used for satisfying a predetermined condition in the video game as an in-game condition; and

a using process configured to cause the character to use the combination of the objects selected in the selecting process in order to satisfy the in-game condition.

(13)

A video game processing method of controlling progress of a video game in response to an operation of a user by a video game processing system, the video game processing system comprising a communication network, a server, and the user terminal, the video game processing method comprising:

a selecting process configured to select a combination of objects in accordance with a progress status of the video game, the objects being to be used for satisfying a predetermined condition in the video game as an in-game condition; and

a using process configured to cause the character to use the combination of the objects selected in the selecting process in order to satisfy the in-game condition.

### INDUSTRIAL APPLICABILITY

According to one of the embodiments of the present disclosure, it is useful to be capable of causing an action of a character for achieving a predetermined purpose in a video game to have the variety while suppressing the burden on developers from increasing.

What is claimed is:

1. A non-transitory computer-readable medium storing a video game processing program for causing a server to perform functions comprising:
controlling a character during progress of a video game;
selecting a combination of objects in accordance with a progress status of the video game, the combination of objects being to be used for satisfying a predetermined in-game condition in the video game; and
causing the character to use the combination of the objects in order to satisfy the in-game condition.

2. The non-transitory computer-readable medium according to claim 1,
wherein selecting the combination of objects includes selecting the combination of objects based on information indicating a property set to each of the objects as property information.

3. The non-transitory computer-readable medium according to claim 2,
wherein selecting the combination of objects includes selecting the combination of the objects based on the property information that is configured to allow the character to perform a predetermined action for satisfying the predetermined in-game condition.

4. The non-transitory computer-readable medium according to claim 1,
wherein selecting the combination of objects includes selecting the combination of the objects from a plurality of objects, each of the plurality of objects satisfying a condition to be selected as a candidate regarding the character.

5. The non-transitory computer-readable medium according to claim 1, the functions further comprising:
determining whether the predetermined in-game condition is satisfied by using the selected combination of the objects regardless of a predetermined determination value.

6. The non-transitory computer-readable medium according to claim 1,
wherein selecting the combination of objects includes selecting the combination of the objects from a plurality of objects other than a predetermined object based on information indicating an action of a character associated with the predetermined object.

7. The non-transitory computer-readable medium according to claim 6,
wherein the plurality of objects other than the predetermined object include an object that has a predetermined relationship with the predetermined object.

8. The non-transitory computer-readable medium according to claim 1,
wherein selecting the combination of objects includes preferentially selecting a combination of objects to be used for satisfying an other in-game condition when the other in-game condition is set before the predetermined in-game condition is satisfied, the other in-game condition having a higher priority than a priority of the predetermined in-game condition to be satisfied.

9. The non-transitory computer-readable medium according to claim 1,
wherein selecting the combination of objects includes selecting the combination of the objects to be used for satisfying the in-game condition using goal orientation planning.

10. A video game processing system comprising:
a communication network;
a server; and
at least one user terminal that is configured to connect with the server via the communication network; and
a computer configured to:
control a character in progress of a video game;
select a combination of objects in accordance with a progress status of the video game, the combination of objects being to be used for satisfying a predetermined in-game condition in the video game; and
cause a character to use the selected combination of the objects in order to satisfy the predetermined in-game condition.

11. A non-transitory computer-readable medium including a video game processing program for causing a user terminal to perform functions comprising:
controlling a character in progress of a video game;
selecting a combination of objects in accordance with a progress status of the video game, the combination of objects being to be used for satisfying a predetermined in-game condition in the video game; and
causing a character to use the selected combination of the objects in order to satisfy the predetermined in-game condition.
